(19) United States
(12) Patent Application Publication
(10) Pub. No.: US 2003/0107597 A1
(43) Pub. Date: Jun. 12, 2003

(54) Collection extensible action GUI

(76) Inventor: Kevin Wade Jameson, Calgary (CA)

Correspondence Address: KEVIN JAMESON, 148 EDGEBANK PLACE NW, CALGARY, AB, T3A 4L4, CA

(21) Appl. No.: 10/003,421

(22) Filed: Dec. 6, 2001

(51) Int. Cl. G09G 5/00

(52) U.S. Cl. 345/762

(57) ABSTRACT

A Collection Extensible Action GUI (graphical user interface) is constructed from user-defined, executable GUI actions, thereby making it possible for users to customize and extend the GUI to suit their precise computational needs.

In operation, a Collection Extensible Action GUI receives an action execution request associated with a menu choice or toolbar button, obtains corresponding descriptive action data from an action data storage means, updates internal GUI data structures according to the obtained action data, executes the requested action, and updates the visible GUI display to reflect the executed action.

A Collection Extensible Action GUI provides users with a scalable, customizable, and extensible GUI interface that can be precisely configured to meet user work requirements, thereby increasing user productivity in ways that were not previously possible.

### CROSS REFERENCE TO RELATED APPLICATIONS

The present invention uses inventions from the following patent applications, which are incorporated herein by reference:

Collection Information Manager, USPTO patent application Ser. No. 09/885,078, filed Jun. 21, 2001, Kevin W Jameson.

Collection Knowledge System, USPTO patent application Ser. No. 09/885,079, filed Jun. 21, 2001 Kevin W Jameson.

Collection Role Changing GUI, USPTO patent application filed contemporaneously herewith, Kevin W Jameson.

### FIELD OF THE INVENTION

This invention relates to graphical user interfaces for processing collections of computer files in arbitrary ways, thereby improving the productivity of software developers, web media developers, and other humans that work with collections of computer files.

### BACKGROUND OF THE INVENTION

The Overall Problem

The general problem addressed by this invention is the low productivity of human knowledge workers who use labor-intensive manual processes to work with collections of computer files. One promising solution strategy for this software productivity problem is to build automated systems to replace manual human effort.

Unfortunately, replacing arbitrary manual processes performed on arbitrary computer files with automated systems is a difficult thing to do. Many challenging sub-problems must be solved before competent automated systems can be constructed. As a consequence, the general software productivity problem has not been solved yet, despite large industry investments of time and money over several decades.

The present invention provides one piece of the overall functionality required to improve the productivity of human knowledge workers—a better graphical user interface (GUI).

In particular, the present Collection Extensible Action GUI has a practical application in the technological arts because it provides a GUI interface whose functionality can be extended to suit the particular needs of various application domains, thereby improving user productivity.

Introduction To GUI Interfaces

The main goal of all user interfaces is to facilitate human productivity by making it convenient and efficient for humans to accomplish work. To this end, various kinds of user interfaces have been created over the years to improve user productivity. Two important types of interfaces are command line interfaces (also known as CLI or shell window interfaces) and graphical user interfaces (GUIs).

Technically speaking, user interfaces provide human users with means for initiating work events that in turn perform work operations. Work events are commonly initiated by typing a command line into a shell window, or by clicking on menu choices or toolbar buttons on a GUI interface. Work operations are typically implemented as independent command line scripts or programs, or as subroutine calls within GUI interface programs.

Dominant CLI Design Strategies

Simply put, there are no dominant CLI design strategies. All CLI interfaces are essentially the same—users type command lines into a CLI window, and the operating system executes the command line. Although Unix command line I/O models (pipes, tees, redirections) from the 1970s were novel, it is substantially fair to say that CLI interfaces have not really changed much in the past several decades.

Dominant GUI Design Strategies

In contrast to CLI interfaces, GUI interfaces have evolved significantly during the past 30 years.

For several decades now, the dominant GUI interface design strategy has been to write a unique GUI interface for each distinct user application domain. For example, unique GUI interfaces have been implemented for spreadsheet programs, word processing programs, email programs, and database programs.

The “one GUI per application domain” design strategy makes sense because each unique GUI interface provides users with a custom set of GUI work operations that are related to the data and operations used within a particular application domain. As a counter example, to illustrate the point again, it makes little sense to provide spreadsheet buttons on a word processing interface, or to provide word processing buttons on a database interface.

The “one GUI per application domain” design strategy also makes sense from a marketing point of view, because a unique GUI interface can be more easily differentiated from other products in the marketplace.

A second part of the dominant GUI design strategy provides a fixed set of work operations for each unique GUI interface. To build an interface, GUI designers study user requirements in an application domain, identify a set of work operations that should be provided by a GUI interface for that domain, then implement those work operations. Thus GUI work operations are tuned to the needs of an application domain.

The “fixed set of work operations” design strategy makes sense because it provides sufficient GUI functionality to meet application domain requirements. Indeed, most mature GUI products in the current marketplace (such as spreadsheets and word processors) provide a large excess of functionality beyond the needs of most users.

To summarize, the two dominant GUI design strategies of “one GUI per application domain” and “a fixed set of work operations” are successful because they substantially satisfy the needs of human users working within an application domain.

Comparison of CLI and GUI Interfaces

Most CLI interfaces have the usual characteristics. That is, they have broad applicability because they can provide access to work operations (programs) in many application domains. Further, they have a consistent interface across all such application domains—there is no visual presentation of available work operations, or means for selecting work operations. Instead, all command lines must be known by human users in advance, and must be manually typed into the CLI interface in the usual way.

In contrast, GUI interfaces have very different characteristics. They have narrow applicability because each GUI provides work operations that are focused on only one application domain. Further, they have different interfaces across application domains—each GUI for each application domain visually presents a different set of work operations that are relevant to that particular application domain. Finally, GUIs present a fixed visual list of available work operations, and work operations must be chosen from the fixed list.

Clearly the two most important interfaces in the current marketplace have very different characteristics. GUIs are new; CLIs are old. GUIs are narrow, focused on one application; CLIs are broad, focused on no application. GUIs have fixed sets of work operations; CLIs have unbounded sets of work operations. GUIs present work operation choices visually; CLIs require advance mental understanding of possible command lines.

These striking differences between GUI and CLI interfaces implicitly pose the question of whether there is a middle ground that could provide the main advantages of both GUI and CLI interfaces in a new kind of interface.

Extensible Action GUIs

The present invention contemplates a new kind of GUI interface that does not follow the “fixed set of work operations” dominant design strategy that was presented above. Instead, the present Collection Extensible Action GUI invention contemplates a GUI interface with an extensible set of work operations.

One key factor in the practicality of this novel design approach is the type of command flow used in the application domains that are served by the present invention.

Types of Command Flow In User Interfaces

Two types of command flow in user interfaces are of interest: linear flow and eddy flow.

Linear command flow occurs when execution proceeds linearly from invocation, through execution, to termination—without further human input during the execution phase. Linear command flow can be seen in most command line programs, scripts, and batch files—once started, they run to completion without further human input. Linear command flow is particularly good for automated processes because no human input is required after invocation.

Eddy command flow occurs when program execution proceeds from invocation, into an iterative command input loop, and to termination only when an exit command is given to the command loop. Eddy flow can be seen in GUI application programs that have internal command loops for receiving user input during the GUI program execution phase. For example, spreadsheets and word processors are good examples of GUI applications that use eddy command flow. Eddy command flow applications are good for interactivity, since they can receive interactive commands from humans, and can display the results of each interactive command immediately. Eddy command flow applications exit only when an exit command is given to the command loop.

Linear and eddy command flows are not generally interchangeable within application domains. To a first approximation, some application domains (such spreadsheets and word processors) require interactive GUI user interfaces with eddy flow for reasonable productivity, and some application domains (such as single-action programs and automated scripts) require command line programs with linear command flow for reasonable productivity.

The relationship between application domain and command flow model is important because it means that mismatches between application domains and user interfaces tend to reduce productivity to discouraging levels.

The present invention contemplates a Collection Extensible Action GUI for use in linear command flow application domains, thereby combining the two ideas of (1) GUI visual presentation and (2) unbounded sets of linear flow CLI work operations (hereafter called “actions”).

Because the set of possible actions provided by a Collection Extensible Action GUI is in principle unbounded, users can add arbitrary numbers of new actions to the GUI to suit their particular computational needs.

In order to construct a Collection Extensible Action GUI, several important technical problems must be solved.

Problems To Solve

The overall Collection Extensible Action GUI Problem is an important problem that must be solved to enable the construction of Collection Extensible Action GUI interfaces for linear command flow applications. It is the problem of how to construct extensible, customizable, sharable, scalable, and user-defined GUI interfaces that can be configured to run linear command flow programs for use in multiple application domains.

A Collection Extensible Action GUI can be extended by adding new actions to the set of existing GUI actions. Actions are defined by action definition files that contain command lines and other information required to carry out the desired function provided by the action.

Some interesting aspects of the Collection Extensible Action GUI Problem are these: arbitrary numbers of application domains may be involved; arbitrary numbers of actions may be required for each application domain; arbitrary numbers of menus, menu choices, and toolbar buttons may be required to effectively model each application.

The Parameterized Action Problem is another important problem that must be solved to enable the construction of Collection Extensible Action GUI interfaces. It is the problem of how to use parameter variables in action definitions in order to improve the flexibility and reuse of user-defined GUI actions.

Some interesting aspects of the Parameterized Extension Function Problem are these: each action may contain several parameters; parameter variable values may change between successive action executions; some parameter values may be calculated dynamically; parameters can be lists of values, instead of being single text strings; actions and their parameters may be customized according to site, project, team, and individual preferences.

The Sequenced Action Problem is another important problem that must be solved to enable the construction of Collection Extensible Action GUI interfaces. It is the problem of how to represent, manage, and execute named sequences of user-defined GUI actions.

Some interesting aspects of the Sequenced Action Problem are these: arbitrary numbers of actions may be involved in a sequence; sequences themselves may be used as steps in other sequences; sequences may be comprised of chains of internal GUI actions, dialogs, selection boxes, and external command executions; all sequences may be customized according to site, project, team, and individual preferences.

The Dynamic List Generation Problem is another important problem that must be solved to enable the construction of Collection Extensible Action GUI interfaces. It is the problem of how to dynamically generate lists of values to be used in user-defined GUI dialogs and selection lists.

Some interesting aspects of the Dynamic List Generation Problem are these: dynamic lists may be obtained from internal GUI subroutines, from external GUI programs, from user inputs, or from remote servers; dynamic lists may be used in GUI selection dialogs, GUI list boxes, in dynamically created files, or in other interactive GUI components; successive and related dynamic lists may be required to “drill down” successive levels of a hierarchical structure, such as through directories in a disk filesystem; and the creation method and use of all dynamic lists may be customized according to site, project, team, and individual preferences.

The Single Action Parallel Execution Problem is another important problem that must be solved to enable the construction of Collection Extensible Action GUI interfaces. It is the problem of executing action command lines in parallel for improved execution performance.

Some interesting aspects of the Single Action Parallel Execution Problem are these: a single action is comprised of one or more action commands; arbitrary action commands may be executed; an arbitrary number of action commands may be executed in parallel; sequences of interleaved sequential action commands and parallel action command execution blocks may be executed, each execution block containing multiple action commands to be executed in parallel; and sequences of parallel command execution blocks, each block containing a set of action commands, may be executed.

The Group Action Parallel Execution Problem is another important problem that must be solved to enable the construction of Collection Extensible Action GUI interfaces. It is the problem of executing multiple single actions in parallel for improved execution performance.

Some interesting aspects of the Group Action Parallel Execution Problem are these: a group action is comprised of one or more single actions; arbitrary single actions may be executed; an arbitrary number of single actions may be executed in parallel; sequences of interleaved sequential single actions and parallel action execution blocks may be executed, each execution block containing multiple single actions to be executed in parallel; and sequences of parallel action execution blocks, each block containing a set of single actions to be executed in parallel, may be executed.

The Customized Action Problem is another important problem that must be solved to enable the construction of Collection Extensible Action GUI interfaces. It is the problem of how to represent and manage site, project, team, and individual customizations for action data used by a Collection Extensible Action GUI.

Some interesting aspects of the Customized Action Problem are these: arbitrary numbers of action definitions may be customized; arbitrary numbers of site, team, project, and individual customizations may be involved; customizations can be platform dependent; customizations can be shared among GUI users; and centralized administration of shared customizations is desirable.

The Shareable Action Problem is another important problem that must be solved to enable the construction of Collection Extensible Action GUI interfaces. It is the problem of sharing user-defined action data among all users and machines in a networked computing environment.

Interesting aspects of the Shareable Action Problem are these: arbitrary numbers of users may be involved; sharable data can be organized into groups of related shared items; users may be organized into groups of related users that share the same action data; individual customizations to shared group action data may also be shared; centralized administration of sharing rules and shared data is desirable.

The Scalable Action Problem is another important problem that must be solved to enable the construction of Collection Extensible Action GUI interfaces. It is the problem of how to manage large numbers of multi-platform, user-defined actions in a networked computing environment.

Some interesting aspects of the Scalable Action Problem are these: arbitrary numbers of action commands may be involved; actions can be accessed by any computer on the network; actions, or groups of related actions, can be shared among many different users, user groups, and platforms; and centralized administration of stored actions is desirable.

As the foregoing discussion suggests, creating extensible GUI interfaces for multiple linear command flow applications is a complex problem involving many degrees of freedom. No competent general solution to the overall problem is visible in the prior art today, even though the first GUI interfaces were created over 30 years ago.

General Shortcomings of the Prior Art

The following discussion is general in nature, and highlights the significant conceptual differences between the single-application, non-extensible GUI interfaces of the prior art, and the novel Collection Extensible Action GUI represented by the present invention.

Prior art approaches lack general support for extensible, linear-flow GUI actions, especially when extensions are provided by non-programmers. This is the largest limitation of all because it prevents prior art approaches from being extended to include new, user-defined actions that could improve human productivity.

Prior art approaches lack general support for parameterized actions, thereby making it impossible to reuse an action by using a parameter variable substitution technique.

Prior art approaches lack general support for executing sequences of actions, thereby limiting the power of actions that are associated with GUI menu choices and toolbar buttons.

Prior art approaches lack general support for executing actions in parallel, thereby limiting the performance and productivity that can be achieved by GUI users.

Prior art approaches lack support for generating dynamic lists of values using extensible means such as external program calls, thereby making it impossible to use dynamic lists in GUI selection boxes, display lists, or in other GUI actions.

Prior art approaches lack support for customizing many different GUI elements (menus, menu choices, toolbars, buttons, actions, parameters, etc), thereby making it impossible to simultaneously serve the custom needs of many GUI projects, teams, and users that each have their own customization preferences.

Prior art approaches lack support for sharing large numbers of user-defined actions (and their respective customizations) among a large population of human users and user groups, thereby making it impossible to reuse user-defined actions effectively.

Prior art approaches lack scalable support for managing large numbers of user-defined actions, thereby making it very difficult to provide a uniform set of actions to a large population of human users in a networked computing environment.

As can be seen from the above description, prior art GUI interface approaches have several important limitations. Notably, they are not generally extensible, customizable, sharable, or scalable.

In contrast, the present Collection Extensible Action GUI has none of these limitations, as the following disclosure will show.

### SUMMARY OF THE INVENTION

A Collection Extensible Action GUI (graphical user interface) is constructed from user-defined, executable GUI actions, thereby making it possible for users to customize and extend the GUI to suit their precise computational needs.

In operation, a Collection Extensible Action GUI receives an action execution request associated with a menu choice or tool bar button, obtains corresponding descriptive action data from an action data storage means, updates internal GUI data structures according to the obtained action data, executes the requested action, and updates the visible GUI display to reflect the executed action.

A Collection Extensible Action GUI thus provides users with a scalable, customizable, and extensible GUI interface that can be precisely configured to meet user work requirements, thereby increasing user productivity in ways that were not previously possible.

### OBJECTS AND ADVANTAGES

The main object of a Collection Extensible Action GUI is to improve human productivity by providing human workers with an extensible GUI interface that can be precisely tuned to meet specific user computational requirements.

Another object is to provide support for parameterized action templates, thereby making it possible for users to reuse the same action template in various situations, by substituting parameter values into the action template at runtime.

Another object is to provide support for executing sequences of actions when a GUI menu choice or button is selected, thereby enabling users to get more processing work done with fewer GUI selection operations, and thereby helping to improve user productivity.

Another object is to provide support for generating dynamic lists of values for use in selection dialogs and actions, thereby enabling users to work with large sets of current data values, and thereby avoiding the maintenance costs associated with static lists of evolving data values.

Another object is to provide support for customizing large numbers of GUI actions, thereby enabling users to customize GUI actions in accordance with site, project, team, and individual customization preferences.

Another object is to provide support—scalable support—for managing large numbers of actions, thereby enabling action administrators to provide users with actions that are drawn from a large, centrally administered pool of actions.

Another object is provide support for sharing large numbers of user-defined and user-customized actions among a large population of users and user groups, thereby enabling a community of users to share the same actions, and thereby gaining the cost and maintenance advantages of software action reuse.

As can be seen from the objects above, Collection Extensible Action GUIs can provide many benefits to human knowledge workers. Extensible Action GUIs can help to improve human productivity by enabling non-programmers to extend GUIs with customized, relevant, and useful new functionality, in ways that were not previously possible.

Further advantages of the present Collection Extensible Action GUI invention will become apparent from the drawings and disclosures that follow.

### BRIEF DESCRIPTION OF THE DRAWINGS

FIG. 1 shows a simplified architecture for a Collection Extensible Action GUI 130.

FIG. 2 shows a simplified algorithm for a Collection Extensible Action GUI 130.

FIG. 3 shows a simplified architecture for a Module Action Request Manager 131.

FIG. 4 shows a simplified algorithm for a Module Action Request Manager 131.

FIG. 5 shows a simplified architecture for a Module Execute Action Manager 150.

FIG. 6 shows a simplified algorithm for a Module Execute Action Manager 150.

FIG. 7 shows a simplified algorithm for a Module Execute Group Action 152.

FIG. 8 shows a simplified architecture for Module Execute Single Action 170.

FIG. 9 shows a simplified algorithm for Module Execute Single Action 170.

FIG. 10 shows a simplified data structure for an incoming action request.

FIG. 11 shows an action name table that associates action names with action definition filenames.

FIG. 12 shows a simplified format for a preferred implementation of an action definition.

FIG. 13 shows several example action definitions, all contained within a single action definition file.

FIG. 14 shows two example actions that use focus variable operations to set and split a focus variable pathname value, respectively.

FIG. 15 shows several examples of focus variables and their corresponding substitution values.

FIG. 16 shows an example dialog name table.

FIG. 17 shows an example dialog definition file that uses a dynamic list.

FIG. 18 shows an example static list name table and two example static lists that list site project names and site personnel names.

FIG. 19 shows an example group action that is comprised of two single actions.

FIG. 20 shows an example implementation of the two single actions from the group action of FIG. 19.

FIG. 21 shows an example parallel single action that uses parallel execution to process action commands.

FIG. 22 shows an example parallel single action that contains an interleaved sequence of sequential and parallel execution blocks.

FIG. 23 shows an example parallel single action that contains a sequence of parallel execution blocks separated by a wait command.

FIG. 24 shows an example parallel group action that uses parallel execution to process single actions.

FIG. 25 shows an example parallel group action that contains an interleaved sequence of sequential and parallel execution blocks.

FIG. 26 shows an example parallel group action that contains a sequence of parallel execution blocks separated by a wait command.

### LIST OF DRAWING REFERENCE NUMBERS

121 Action Data Storage Means

130 Collection Extensible Action GUI

131 Module Action Request Manager

132 Module Get Action Identifier

140 Module Get Action Definition

150 Module Execute Action Manager

151 Module Get Action Type

152 Module Execute Group Action

170 Module Execute Single Action

171 Module Substitute Focus Variables

172 Module Execute Action Command Internal

173 Module Execute Action Command External

174 Module Execute Action Focus Variable Operations

175 Module Execute Action Dialog

176 Module Get Dynamic List

200 Module Output Action Results

### DETAILED DESCRIPTION

GUI Architecture Terminology

This section defines various terms used in this document.

A GUI Role is a set of related GUI menus, toolbars, and underlying executable actions that is designed to support a particular type of human work. The main idea behind a GUI role is to provide human workers an optimal set of menu choices and toolbar buttons for accomplishing the particular type of work that is currently being done. For example, a human working in a programmer role would be provided with menus and buttons useful for programming. A human working in a documenter role would be provided with menus and buttons useful for working with documents. A human working as a team manager would be provided with menus and buttons useful for working with teams, projects, timesheets, task lists. And so on. In a technical sense, GUI roles are comprised of a GUI layout and optional focus variables and associated values.

A GUI Layout specifies a list of menubars and toolbars that are visibly displayed on a computer display screen. Layouts determine the set of menu choices and toolbar buttons that are visibly provided to human workers.

A GUI Menubar specifies a list of menus that are visibly displayed across the top of a GUI display window. Most menubars contain the popular File, Edit, View, and Help menus.

A GUI Menu specifies a list of menu choices that are visibly displayed below a menu name on a menubar. Menu choices represent a major part of the operative functionality that is available through a GUI interface (toolbar buttons provide the rest of the functionality). For example, most File menus contain the popular File New, File Open, File Save, and File Save As menu choices.

A GUI Menu Choice is an individual choice on a GUI menu. A menu choice invokes a GUI action to perform useful computational work. For example, a File Save menu choice could invoke a GUI action to save a current document onto a computer disk.

A GUI Toolbar specifies a list of buttons (or other GUI controls) that are visibly displayed below a menubar on a GUI window. Multiple toolbars may be displayed on many modern GUI interfaces. For example, many toolbars contain the popular New, Open, Save, Cut, Copy, and Paste buttons.

A GUI Toolbar Button is an individual button on a toolbar. A toolbar button invokes a GUI action to perform useful computational work. For example, a File Save button could invoke a GUI action to save a current document onto a computer disk.

A GUI Action is a technical means that implements the function of an individual menu choice or toolbar button. GUI actions are typically implemented by executing internal GUI program code, by making external operating system calls, or by a combination of both. GUI actions typically use dialogs, dynamic lists, and focus variables to accomplish their computational functions.

A GUI Focus Variable is an internal GUI variable that can hold text strings of interest to the GUI role or to the human user. Focus variables are user-definable, so users can define their own variables and associated values. The main purpose of focus variables is to provide runtime substitution values for placeholder (parameter) variable names in executable action templates.

A GUI Focus Variable Group is a group of internal GUI focus variables. The main purpose of a focus variable group is to keep related focus variables together so their values can be managed as a set. Focus variable groups are user-definable, so users can define their own groups of focus variables and associated values.

A GUI Dialog is a pop-up GUI window that interacts with human GUI users. One example of a typical GUI dialog is a selection dialog, which provides a list of values to a human user that selects one or more values of interest.

A GUI List is a list of static values that is used in action dialogs or action command lines. The main purpose of static lists is to provide lists of items that comprise a set. For example, a list might contain a static list of site projects, repositories, or personnel categories. Static lists are useful for listing things that do not change frequently.

A GUI Dynamic List is a list of current values that is obtained at runtime, and then is used in action dialogs or action command lines. The main purpose of dynamic lists is to provide actions with a way of obtaining current lists of values for use in selection dialogs. For example, a dynamic list might be used to query a remote server for a list of current items stored on the server, so that local GUI users could select interesting values from the dynamic list. Dynamic lists are most useful for listing sets of things whose membership changes frequently.

GUI Action Terminology

An Action Request is an incoming request to perform a particular computation on behalf of the request originator. Action requests are typically generated by humans who use mouse clicks on menu choices or toolbar buttons to initiate the execution of associated GUI actions.

An Action Type Indicator describes the type of action named in an action request. Action types can be either “single action” (execute a single action) or “group action” (execute a sequence of single actions).

An Action Definition defines the name, type, description, content, and other attributes of executable GUI actions. Action definitions are contained within action definition files. Action definitions specify computations that must be carried out in order to fulfill a corresponding action request.

An Action Command is an external operating system command template that is executed as part of performing a requested action. Multiple action commands may be contained within a single action.

An Action Data Storage Means is a data storage means that stores GUI action data outside the GUI itself. An action data storage means can generally store all data used by a Collection Extensible Action GUI. Stored GUI action data can be created, accessed, and shared by multiple human users without using compilers or other special GUI programming tools. For example, three preferred action storage means are ASCII files, relational databases, and Collection Knowledge Systems (see the section on related patent applications for more information on Collection Knowledge Systems).

A Context Sensitive Action Data Storage Means is an action data storage means that can return different answers to data lookup queries, depending on the value of a context token provided as part of the data query. Collection Knowledge Systems are context sensitive.

Extensible GUI Action Data

The intent of this material is to provide readers with an overview of how GUI actions can be modeled by simple, user-defined action data files.

This section is an introduction to the structure and organization of Action Data files. Action Data files model a GUI from the action level (mid-level) through to executable commands (low-level).

In contrast, Role Data files model GUI functionality from the layout level (high-level) to the action level (mid-level). For an introduction to the structure and organization of role data files, see the related patent application “Collection Role Changing GUI” listed in the Related Patent Applications section at the beginning of this document.

Although the examples shown below use simple ASCII files for presentation clarity, readers of ordinary skill in the art will immediately appreciate that the ASCII files shown here could easily be implemented using various, more advanced data storage means, including relational databases.

GUI Actions

A GUI Action is a technical means that implements the intended work function of individual menu choices or toolbar buttons. When menu choices or toolbar buttons are selected with mouse clicks, an associated GUI action is executed.

GUI actions are implemented by internal GUI program code, by external operating system calls, or by a combination of both. GUI actions may use dialogs, dynamic lists, focus variables, subroutines, or external programs to accomplish their computational goals.

FIG. 11 shows an example action name table. Column 1 contains action names. Column 2 contains corresponding action definition filenames.

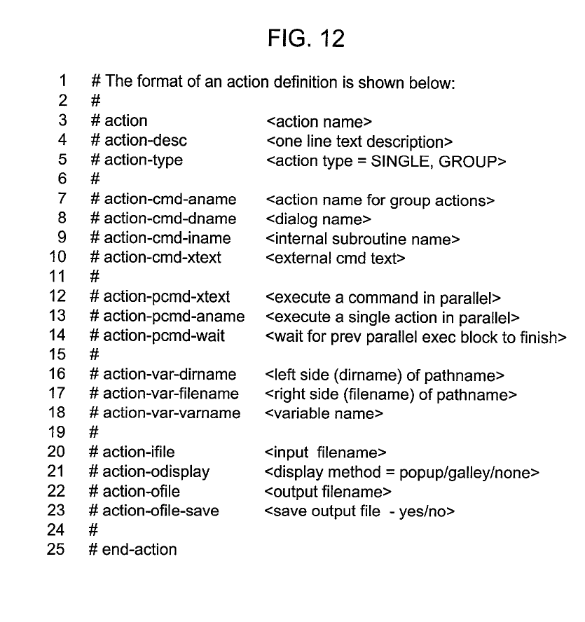

FIG. 12 shows a generic example of a preferred implementation of an action definition. The particular content of an action definition file is determined by the implementation; it can contain whatever information the implementation requires.

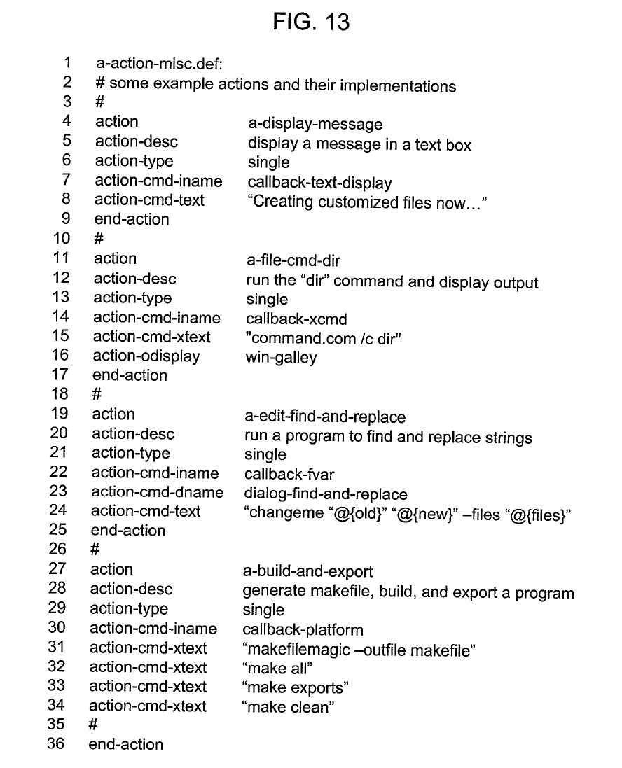

FIG. 13 shows an example action definition file that contains four action definitions.

To execute a particular action, a GUI looks up an action name such as “a-file-cmd-dir” in Column 1 of an action name table FIG. 11 Line 16 to obtain the name of a corresponding action definition file “a-action-misc.def” from Column 2. Action definition information for the desired action is read from an action definition file FIG. 13 Lines 11-17 for use in executing the work specified by the action of interest.

GUI Single Actions

GUI Single Actions are action definitions that perform executable work without calling any other actions. That is, single actions do executable work using subroutine calls, action commands (external programs), dialogs, or other low-level action mechanisms. Single actions are useful for doing simple work that requires few computational steps.

FIG. 13 shows an example action definition file containing four single actions. The “action-cmd-iname” field Line 14 specifies which generic GUI internal subroutine oversees execution of the action. Other fields such as “action-cmd-xtext” Line 15 provide data for the action.

Note that FIG. 13 Lines 27-34 specify an action that contains multiple “action-cmd-xtext” action commands to be executed as part of the action. Even so, this action is a single action because it does not use other actions to perform its work.

GUI Group Actions

In contrast, Group Actions are action definitions that are comprised of lists of single action names. Group Actions do no executable work themselves; instead they call other single actions to perform required work. Group actions are useful for doing more complex work that requires several computational steps. Normally, each computational step in a group action is performed by a separate single action.

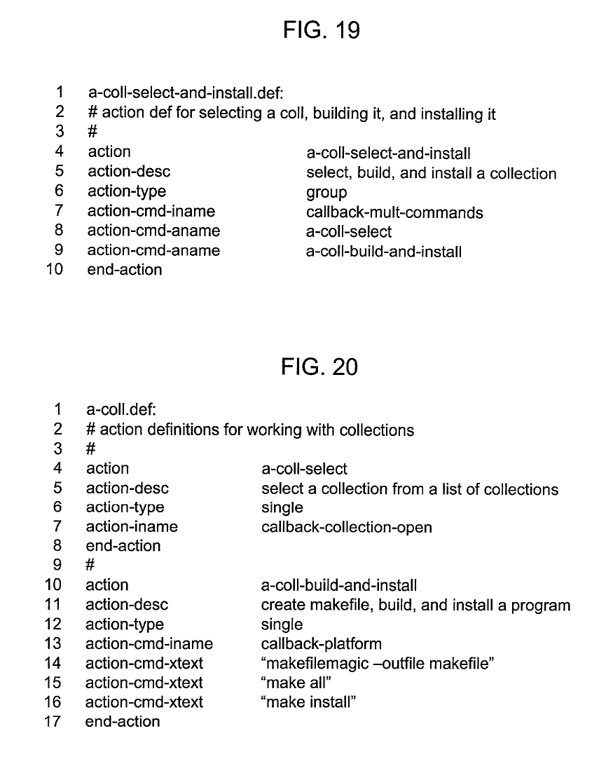

FIG. 19 shows an example group action definition file. Lines 8-9 specify the names of single actions that implement the function of the group action.

FIG. 20 shows an example action definition file that contains two single action definitions that implement the function of the group action shown in FIG. 19.

GUI Parallel Actions

GUI Parallel Actions are actions that use parallel processing techniques such as threads or child processes to perform multiple computations simultaneously. Parallel Single Actions run action commands (external operating system commands) in parallel. Parallel Group Actions run whole single actions in parallel.

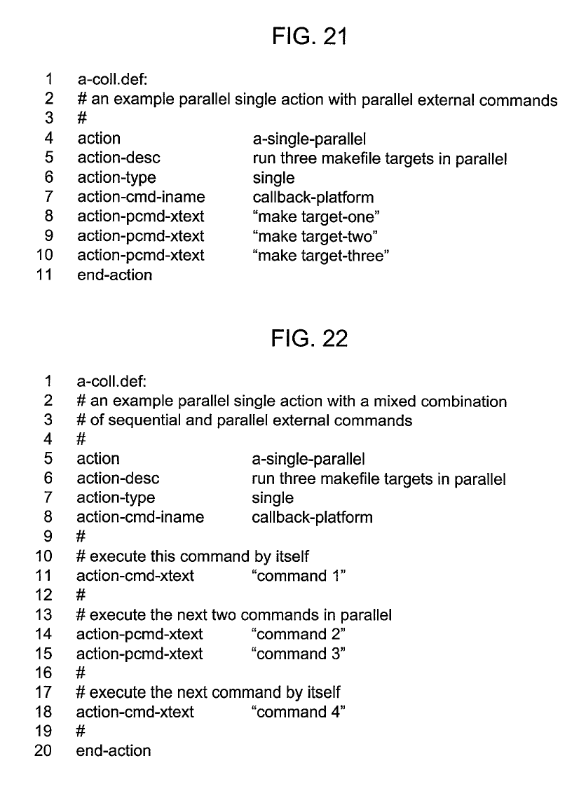

FIG. 21 shows an example single action definition that executes several external operating system commands in parallel. Parallel execution is indicated by the “action-pcmd-xtext” tag Lines 8-10. In operation, a GUI executes all operating system commands in parallel, and waits until all single actions are complete, before organizing and displaying all output in a linear fashion.

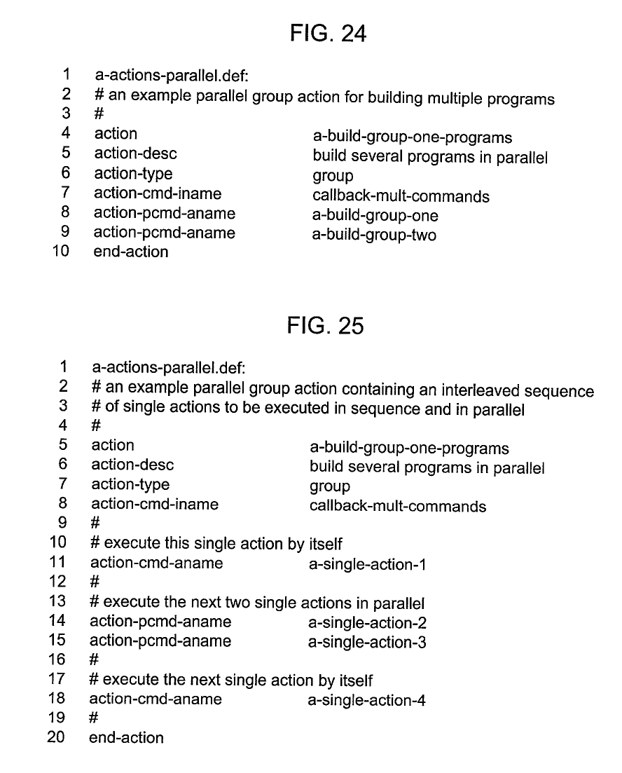

FIG. 24 shows an example group action definition that executes several single actions in parallel. Parallel execution is indicated by the “action-pcmd-aname” tag Lines 8-9. In operation, a GUI executes all single actions in parallel, and waits until all single actions are complete, before organizing and displaying all output in a linear fashion.

GUI Focus Variables

A GUI Focus Variable is an internal GUI variable that can hold text strings of interest to the GUI role or to the human user. The main purpose of focus variables is to provide runtime substitution values for placeholder (parameter) variable names in executable command templates.

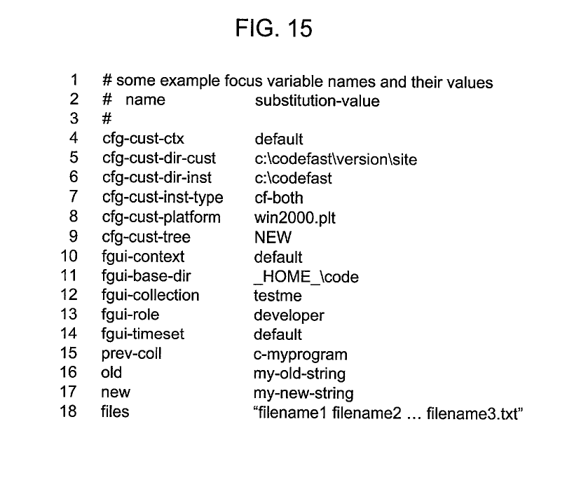

FIG. 15 shows a list of example focus variables and their values.

FIG. 13 Line 24 shows an example action command that contains three placeholder strings “old”, “new”, and “files” for focus variable substitution values. At runtime, the placeholder strings would be replaced with values from focus variables FIG. 15 Lines 16-18.

Focus variables are user-definable, so users can define their own variables and associated values for use in external operating system commands contained within user-defined action definitions.

GUI Dialogs

A GUI Dialog is a pop-up GUI window that provides information to, and collects information from, human GUI users. One example of a typical GUI dialog is a selection dialog—a list of values is provided to a human user, who then selects one or more values of interest.

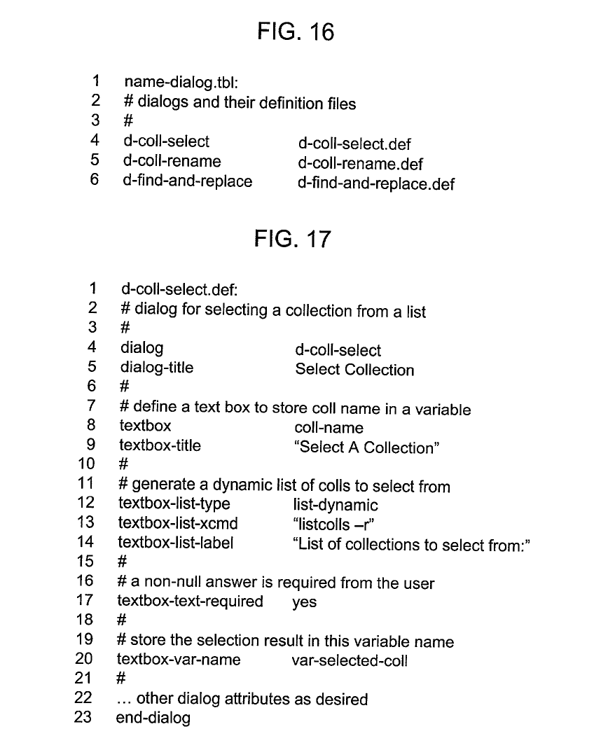

FIG. 16 shows an example dialog name table. Column 1 contains dialog names. Column 2 contains dialog definition filenames.

FIG. 17 shows an example dialog definition file. Column 1 contains dialog tags that define dialog attributes. Column 2 contains attribute values. The particular contents of dialog definition files are determined by the implementation; dialog definition files can contain whatever information is required by the implementation design goals.

To activate a particular dialog, a GUI looks up the desired dialog name in a dialog name table FIG. 16 Column 1 to obtain a corresponding dialog definition filename FIG. 16 Column 2. Dialog definition information is then read from a dialog definition file FIG. 17 for use in activating the dialog of interest.

GUI Lists

A GUI List is a list of static values that can be used in action dialogs or action commands. Static lists are primarily used in selection dialogs.

For example, a list might contain a static list of site projects, repositories, or personnel categories, so that local GUI users could select interesting values from the static list. Static lists are useful for listing sets of things whose membership does not change frequently.

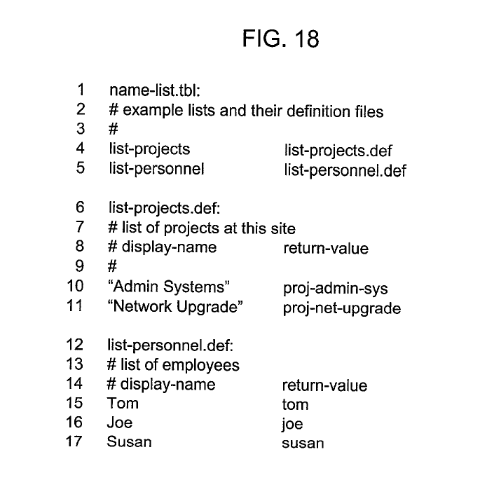

FIG. 18 shows an example static list name table Lines 1-5 and two example static lists Lines 6-11, Lines 12-17.

GUI Dynamic Lists

A GUI Dynamic List is a list of values that is obtained at runtime, and is then used in action dialogs or action commands. The main purpose of dynamic lists is to provide actions with a way of obtaining a list of current values for use in selection dialogs.

For example, a dynamic list might be used to query a remote server for a list of current items stored on the server, so that the local GUI user could select an interesting value from the returned dynamic list.

FIG. 17 shows an example action definition that uses an action command Line 13 to create a dynamic list.

This concludes the introduction to Extensible GUI Action Data files.

Collection Extensible Action GUI

A Collection Extensible Action GUI has four major components.

One component is a GUI framework which provides means for creating a GUI user interface. Software subroutines frameworks for constructing GUI interfaces are usually provided by the operating system.

A second component is a software means for obtaining, interpreting, and executing stored action data. This component contains the algorithms that distinguish a Collection Extensible Action GUI from other GUI programs.

A third component is a set of stored action data that defines executable GUI actions. The stored action data is customizable, extensible, scalable, and may contain a significant portion of custom, user-defined information.

A fourth component is an Action Data Storage Means 121 used to store and manage action data. The present invention contemplates a typical database or a Collection Knowledge System for managing stored action data. For more information on Collection Knowledge Systems, see the related patent applications listed at the beginning of this document.

The following discussion explains the overall architecture and operation of a Collection Extensible Action GUI.

Extensible Action GUI Architecture

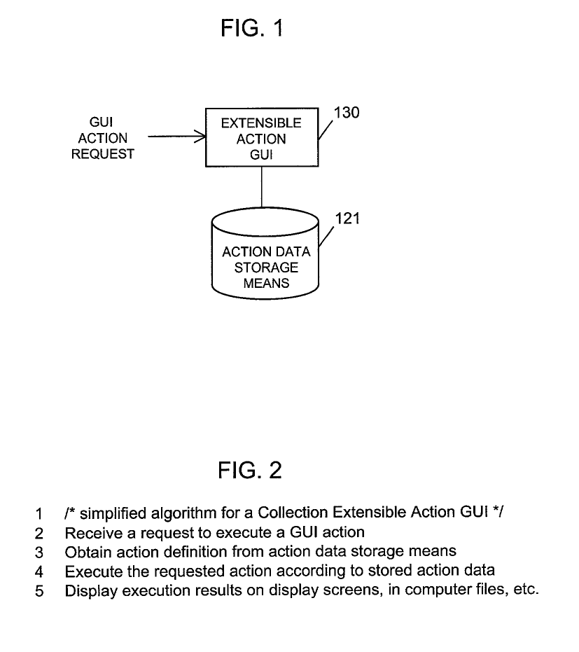

FIG. 1 shows a simplified architecture for a Collection Extensible Action GUI 130.

Module Collection Extensible Action GUI 130 receives incoming action requests generated from mouse clicks on menu choices or toolbar buttons, and executes corresponding GUI actions in response.

Module Action Data Storage Means 121 stores action data in the form of executable action definitions that specify how a Collection Extensible Action GUI 130 should carry out requested actions.

FIG. 2 shows a simplified algorithm for a Collection Extensible Action GUI 130.

In operation, Module Collection Extensible Action GUI 130 first receives a GUI action request. Next, it interprets the request with the help of stored action data obtained from an Action Data Storage Means 121. Then it performs the requested GUI action in accordance with the obtained stored action data. Finally, it dispatches execution results using display screens, computer files, communication networks, or other data communication means.

Module Action Request Manager

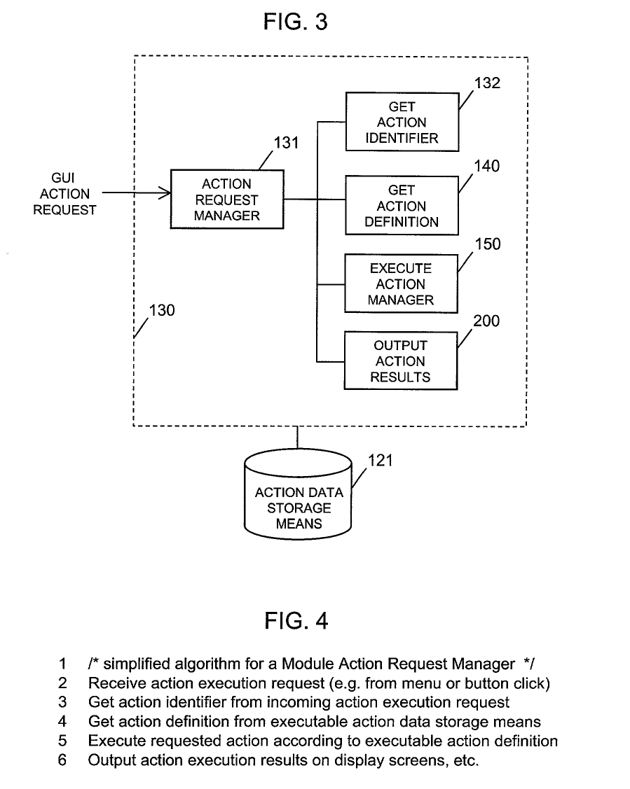

FIG. 3 shows a simplified architecture for a Module Action Request Manager 131.

Module Action Request Manager 131 oversees the interpretation of incoming action requests and the corresponding action responses that are specified by stored action data.

Module Get Action Identifier 132 obtains an action identifier from an incoming action request. Normally the action identifier is the name of an action known to the GUI implementation, such as “a-coll-file-save” FIG. 11 Line 8.

Module Get Action Definition 140 uses an obtained action identifier and an Action Data Storage Means 121 to produce an action definition that specifies how the requested action is to be carried out.

Module Execute Action Manager 150 uses an action definition, produced by Module Get Action Definition 140, to carry out the computations necessary to fulfill the original action request.

Module Output Action Results 200 organizes and dispatches execution results to computer display screens, disk files, or network connections.

Operation

FIG. 4 shows a simplified algorithm for a Module Action Request Manager 131.

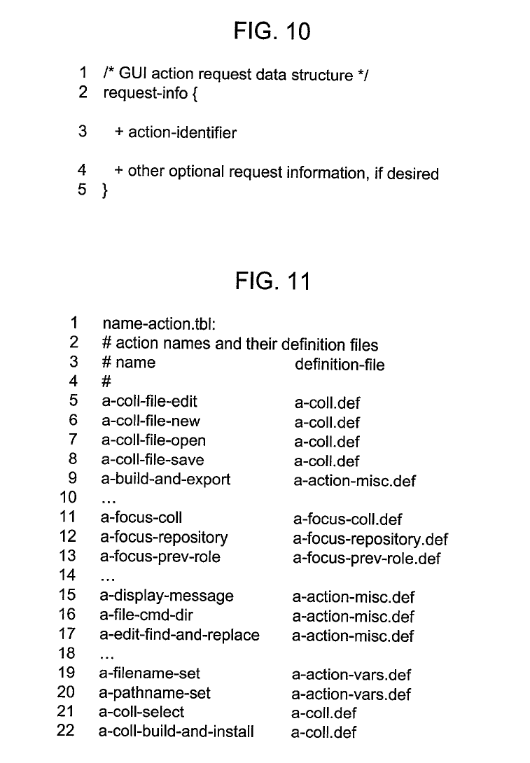

FIG. 10 shows a simplified data structure for an incoming action request. Line 3 shows the essential part of the request—the name of the requested action.

First, Action Request Manager 131 passes an incoming action request FIG. 10 to Module Get Action Identifier 132, which obtains an action identifier from the incoming action request. In one preferred implementation, the action identifier is a text string that specifies the action name, such as “a-coll-file-save” FIG. 11 Line 8.

Module Get Action Identifier 132 obtains an action identifier from the incoming action request by normal computational means well known to the art. Typical techniques include looking up and copying a string value that represents the action name, creating a pointer to an existing string name, or de-referencing a numeric code that identifies the actions.

Next, Action Request Manager 131 passes the obtained action identifier to Module Get Action Definition 140 for de-referencing. In response, Module Get Action Definition 140 uses an Action Data Storage Means 121 to produce an action definition that specifies a computation to be performed to fulfill the original action request.

Next, Action Request Manager 131 passes the produced action definition to Module Execute Action Manager 200, which uses the action definition to perform the requested computations, thereby satisfying the original action request.

Finally, Action Request Manager 131 calls Module Output Action Results 200 to dispatch computational results to computer display screens, files, etc.

Action Definitions

FIG. 11 shows an action name table that associates action names in Column 1 with action definition filenames in Column 2. In operation, GUI modules look up action names in the action name table to obtain the name of a corresponding action definition file that contains the desired action definition.

FIG. 12 shows a simplified symbolic structure for a preferred implementation of an action definition. However, other implementations are also possible. The particular structure of an action definition is determined by the design needs of the implementation, and can vary according to how the implementation chooses to represent actions.

FIG. 12 Lines 3-5 describe the action name, purpose, and the action type.

FIG. 12 Line 7, used only in group actions, shows how to specify the name of another action to call as part of the group. For example, FIG. 19 Lines 8-9 show how a sequence of action names are specified in a group action.

FIG. 12 Line 8 shows how to specify the name of a dialog to be executed as part of a single action. Dialogs are normally used to interact with human users, for data display and collection purposes.

FIG. 12 Line 9 shows how to specify the name of an internal GUI subroutine to be used to execute the current action. For example, FIG. 13 Line 7 shows the name of a subroutine “callback-text-display” that will display a text message on a computer screen. FIG. 13 Line 14 shows the name of a subroutine that will execute an external operating system command string. FIG. 13 Line 22 shows the name of a subroutine that will perform focus variable substitution into a command string Line 24, and then execute the substituted command string. The number and action of such internal GUI subroutines is not fixed, and is determined by the design of the implementation.

FIG. 12 Line 10 shows how to specify the name of an internal GUI subroutine that will execute an action command (an external operating system command) as part of the action.

FIG. 12 Lines 12-14 show how to execute action commands Line 12 and group actions Line 13 using parallel execution techniques for improved action execution performance. Line 14 shows how to separate adjacent parallel execution blocks so they are executed separately by the implementation.

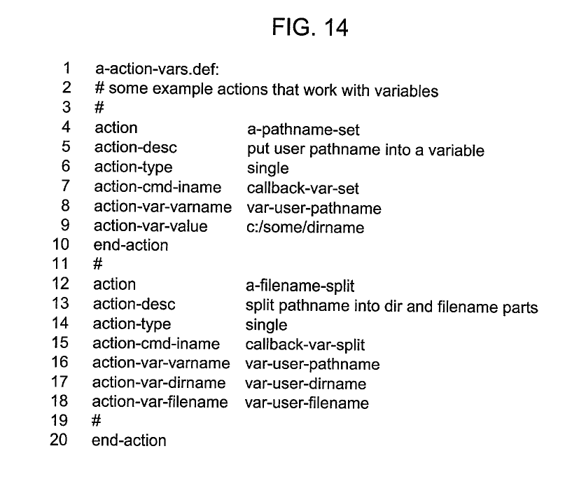

FIG. 12 Lines 16-18 show how to specify data arguments to focus variable actions such as the ones shown in FIG. 14. As an example, the focus variable action shown in FIG. 14 Lines 4-10 stores a pathname value “c:/some/dirname” Line 9 into a focus variable named “var-user-pathname” Line 8.

FIG. 12 Line 20 shows how to specify the name of an input file for use in an action.

FIG. 12 Line 21 shows how to specify how action output results should be displayed; in a pop-up GUI window, in the main GUI scrolling text display window, or not displayed at all.

FIG. 12 Line 22 shows how to specify the name of an output file for use in an action.

FIG. 12 Line 23 shows how to specify whether an output file should be permanently saved or not. Some output files are temporary within a sequence of action commands, and are normally removed once action execution has completed. Other output files should be preserved after execution is complete.

Other action capabilities are also possible, as required by each particular implementation; FIG. 12 is only an example of one possible preferred action definition implementation.

Module Get Action Definition

Module Get Action Definition 140 obtains an action definition by looking up an action identifier in Column 1 of an action name table FIG. 11, to obtain an action definition filename from Column 2 of the table. The desired action definition is read from the obtained action definition file.

For example, suppose an incoming action identifier had the value of “a-build-and-export.” Then Module Get Action Definition 140 would find a match in the action name table FIG. 11 Line 9, and would obtain a corresponding action definition filename of “a-action-misc.def.”

FIG. 13 shows several example action definitions, all contained within a single action definition file “a-action-misc.def.” The action definition for action “a-build-and-export” begins on FIG. 13 Line 27 of the action definition file.

Action “a-build-and-export” is a single action that executes multiple action commands (external operating system commands). This action generates a makefile, then uses targets within the generated makefile to build the program and export it to a remote destination. The internal GUI subroutine that executes the action is named “callback-platform,” which indicates that the makefile, build, and export operations are platform dependent operations.

FIG. 13 shows how multiple action definitions can be placed within a single physical file. However, each definition could be placed into a separate physical file within the Action Data Storage Means 121 if so desired by the implementation.

Module Execute Action Manager

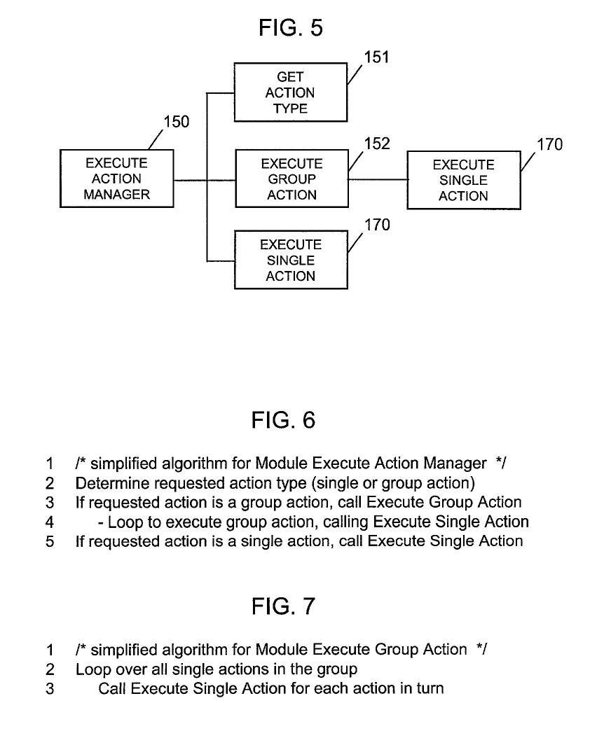

FIG. 5 shows a simplified architecture for a Module Execute Action Manager 150.

Module Execute Action Manager 150 uses an action definition produced by Module Get Action Definition 140 to carry out the computations necessary to fulfill the original action request.

Module Get Action Type 151 obtains an action type indicator from an action definition produced by Module Get Action Definition 140, to determine which module should be called to execute the action.

Module Execute Group Action 152 executes a group action by making successive calls to Module Execute Single Action 170, one call for each single action in the group.

Module Execute Single Action 170 executes a single action definition, making use of various execution facilities such as internal GUI subroutines, external operating system commands, interactive dialogs, dynamic value lists, and focus variable substitutions to carry out the action.

Operation

FIG. 6 shows a simplified algorithm for a Module Execute Action Manager 150.

In operation, Module Execute Action Manager 150 obtains an action type by calling Module Get Action Type 151, and then calls an appropriate subordinate module to execute the action. If the action type indicates a single action, Module Execute Single Action 170 is called. If the action type indicates a group action, Module Execute Group Action 152 is called.

FIG. 7 shows a simplified algorithm for a Module Execute Group Action 152.

In operation, Module Execute Group Action 152 iterates over each action in the group, calling Module Execute Single Action 170 or Module Execute Group Action 152 once for each action specified in the group. For example, FIG. 19 Lines 8-9 show two single actions in a group action. In order to process these two single actions, Module Execute Group Action 152 would make two calls to Module Execute Single Action 170.

While processing a group action, if a single action within a group action is to be executed, Module Execute Single Action 170 is called. Alternatively, if a group action within a group action is to be executed, Module Execute Group Action 152 is called. Action types required for this determination are obtained as described previously, with the help of Module Get Action Type 151.

Module Execute Single Action

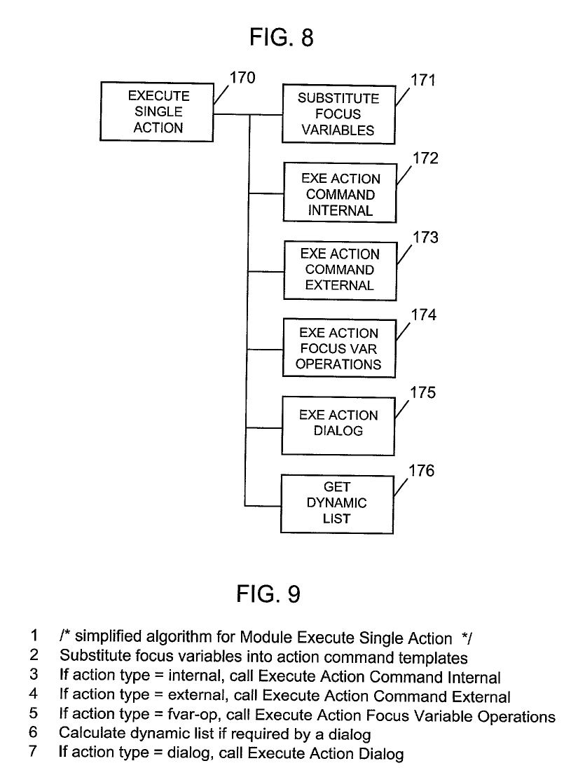

FIG. 8 shows a simplified architecture for Module Execute Single Action 170.

Module Execute Single Action 170 executes a single action definition, making use of various execution facilities such as internal GUI subroutines, external operating system commands, interactive dialogs, dynamic value lists, and focus variable substitutions.

Module Substitute Focus Variables 171 substitutes current focus variable values into placeholder locations within action command templates, thereby customizing and instantiating action command templates with current GUI focus variable values.

FIG. 15 shows example focus variables in Column 1 and their substitution values in Column 2.

Module Execute Action Command Internal 172 calls an internal GUI subroutine module to perform a required internal GUI action.

Module Execute Action Command External 173 makes external calls (outside the GUI) to the operating system, to execute various external programs.

Module Execute Action Focus Variable Operations 174 performs string operations (set, split, join, etc.) on internal GUI focus variable values. FIG. 14 shows two example actions that use focus variable operations to set and split a focus variable pathname value, respectively.

Module Execute Action Dialog 175 creates and manages action dialogs on the host computer screen in order to interact with users.

Module Get Dynamic List 176 calculates a dynamic list of values for use in action dialogs and action commands.

Operation

FIG. 9 shows a simplified algorithm for Module Execute Single Action 170, which calls various internal subroutines in order to carry out required processing tasks.

A single action can contain multiple internal and external action commands.

As one example, FIG. 13 Lines 22-24 specify several operations that comprise a single action. Line 22 specifies the name of an internal GUI subroutine that oversees the execution of this single action. Line 23 specifies a dialog name for collecting two “find and replace” strings and a list of filenames. Line 24 specifies an action command (external operating system program) to perform the desired find and replace operations.

As a second example, FIG. 13 Lines 30-34 also specify several operations that comprise a single action. Line 30 provides the name of an internal GUI subroutine that oversees the execution of the action. Lines 31-34 specify a sequence of action commands (external operating system commands) to generate a makefile and then execute various makefile targets from within the generated makefile.

Actions: Focus Variable Substitution

If required, Module Substitute Focus Variables 171 is called to insert current focus variable values FIG. 15 into placeholder locations within action command templates. For example, FIG. 13 Line 24 shows an external command template containing focus variable placeholder strings “@{old}”, “@{new}”, and “@{files}”. Module Substitute Focus Variables 171 replaces these placeholders with the values of focus variables “old”, “new”, and “files” from FIG. 15 Lines 16-18, respectively.

Actions: Internal Commands

If required, Module Execute Command Internal 172 is called to oversee the execution of an internal operation. For example, FIG. 13 Line 7 specifies that Module Execute Command Internal 173 should call internal subroutine “callback-text-display” to display the text string shown in Line 8. Module Execute Command Internal 172 can call any callback subroutine that executes an internal command.

Actions: External Commands

If required, Module Execute Command External 173 is called to oversee the execution of external operating system commands. Various internal subroutines can be called to oversee variations in how external commands are executed.

As one example, FIG. 13 Line 14 “callback-xcmd” executes a sequence of external operating system command lines in the current working directory.

As a second example, FIG. 13 Line 30 “callback-platform” executes a sequence of external operating system commands from within the platform directory of a collection. For more information on collections, see the related patent application “Collection Information Manager” listed at the beginning of this document.

As a third example, FIG. 13 Line 22 “callback-fvar” first substitutes focus variable values into a command line template Line 24 and then executes the instantiated command line in the current working directory.

The numbers of, and actions of, internal and external callback subroutines are determined by the design goals of the implementation.

Actions: Focus Variable Operations

If required, Module Execute Focus Variable Operations 174 is called to oversee various string operations (e.g. set, join, split) on pathnames stored in focus variables. Focus variable operations are useful when actions work with pathnames containing both a directory portion and a filename portion.

FIG. 14 shows two example actions that use focus variable operations to set and split a focus variable pathname value, respectively.

Actions: Dialogs

If required, Module Execute Action Dialog 175 is called to display dialog boxes to interact with human users. FIG. 16 shows an example dialog name table. FIG. 17 shows an example dialog definition file. In operation, Module Execute Dialog 175 obtains the name of a dialog to execute from an action definition FIG. 13 Line 23, looks it up in a dialog name table FIG. 16 Line 6, and then reads information from a dialog definition file such as shown in FIG. 17.

A dialog definition file contains information required to construct and manage a dialog box that interacts with a human user. For example, FIG. 17 Lines 4-5 specify the name and display title of a dialog. Lines 7-9 specify a selection textbox to be displayed as part of the dialog. Lines 11-14 specify the displayed label and contents of the dialog selection textbox. The contents of this selection textbox are comprised of a list of collections to choose from. Lines 16-17 specify that users must provide a non-null selection value, and Lines 19-20 specify where the results of the selection dialog—the selected collection name—are to be stored. The technical programming techniques for using dialog definition information FIG. 17 to display a dialog box on a computer screen and collect a result are ubiquitous within the programming industry, and have been well known to the art for two decades or more.

Actions: Dialog Dynamic Lists

If required, Module Get Dynamic List 176 is called to obtain a list of dynamic values for use in a dialog. Dynamic lists are usually displayed in dialog selection boxes. Dynamic lists are useful because they are a practical means for dynamically obtaining lists of current (evolving) information. In contrast, some static lists can go out of date very quickly if the evolution rate of the listed information is high.

FIG. 17 Lines 12-13 show a dynamic list specification for use in a dialog selection textbox. Line 12 specifies that the list type for the textbox is “list-dynamic.” Line 13 shows an external operating system command that can be executed to produce a list of values. In this example, the action command Line 13 lists all collections (recursively) below the current working directory. The returned list of recognized collections is displayed in the dialog selection textbox.

Actions: Dialog Static Lists

Dialog definition files can also use static lists as sources of information to display in dialog textboxes.

FIG. 18 shows an example static list name table Lines 1-5 and two example static lists Lines 6-11, Lines 12-17. In operation, a dialog definition file FIG. 17 Line 12 would specify a list type of “list-static,” and FIG. 17 Line 13 would specify a valid static list name from a list name table FIG. 18 Column 1.

Actions: Group Actions

A group action is comprised of other actions. Normally (but not always) the actions that comprise a group action are single actions.

FIG. 19 shows an example group action that is comprised of two single actions. Line 8 names a single action to select a collection from a list of collections. Line 9 names a single action to build and install the collection selected by the action named in Line 8.

FIG. 20 shows how the two single actions from FIG. 19 are implemented. The first action Lines 4-8 is implemented internally as a subroutine. The second action Lines 10-17 is implemented using a sequence of external action commands.

In operation, Module Execute Group Action 152 would be called to execute the group action shown in FIG. 19. It would iterate over each single action in the group, calling Module Execute Single Action 170 once for each single action specified in the group. For example, Module Execute Group Action 152 would make two calls to Module Execute Single Action 170 in order to process the two single actions shown in FIG. 19 Lines 8-9.

To process a single action that is part of a group, Module Execute Group Action 152 extracts a single action name from a group action definition (e.g. “a-coll-select” from FIG. 19 Line 8 Column 2). The extracted name is passed to Module Execute Single Action 170, which looks up the single action name in an action name table FIG. 11 Line 21, obtains a corresponding action definition file name, reads information from a corresponding action definition instance FIG. 20 Lines 4-8, and finally executes the specified single action definition.

To process a group action that is part of a group, Module Execute Group Action 152 extracts a group action name from a group action definition. The extracted group action name is then passed to Module Execute Group Action 152, which proceeds as described previously. Full recursive behavior is not supported by the preferred implementation described here. But full recursive behavior is possible, and may be supported by implementations that choose to offer it.

The sequential process of “extract action name, look up action definition, execute action definition” is repeated for each action in the group action definition, unless parallel execution is used.

Actions: Parallel Single Actions

Parallel single actions can execute action commands in parallel.

FIG. 21 shows an example single action that uses parallel execution to process action commands within the action. Parallel execution of action commands is indicated by the “action-pcmd-xtext” token on Lines 8-10. Comparison with non-parallel action definition lines FIG. 20 Lines 14-16 shows the difference in syntax for indicating parallel and sequential operation (“-pcmd-” vs “-cmd-”).

Parallel single actions use parallel execution techniques to execute commands within the action. Several parallel execution techniques that are well known to the art are possible, including multiple threads of execution, multiple child processes, multiple jobs spawned into a parallel job execution system, and distributed execution on multiple networked computers.

In operation, Module Execute Single Action 170 uses a parallel execution technique (such as multiple threads) to execute parallel command actions indicated by “action-pcmd-xtext” tokens in the action definition file FIG. 21 Lines 8-10. For example, all commands named in FIG. 21 Lines 8-10 are executed in parallel. Execution of each individual external command is still performed by Module Execute Action External Command 173, but each such execution is done in parallel with others in its parallel execution block.

External commands can be organized into sequences of interleaved sequential and parallel execution blocks.

FIG. 22 Lines 10-18 show how 4 commands can be organized into 3 execution blocks, as follows: command 1 in sequence, commands 2 and 3 in parallel, command 4 in sequence. Module Execute Single Action 170 waits for all parallel command executions in a parallel execution block to finish before proceeding. Thus it would wait for commands 2 and 3 to finish before starting execution of command 4. Techniques for waiting for parallel processes to finish are well known to the art.

Module Execute Single Action 170 can detect the boundaries of interleaved sequential and parallel execution blocks by examination of the token names in Column 1 of an action definition file FIG. 22. A change from “action-cmd-xtext” Line 11 to “action-pcmd-xtext” Line 14 (or a vice versa change in the opposite direction from Line 15 to Line 18) indicates the boundary of an execution block.

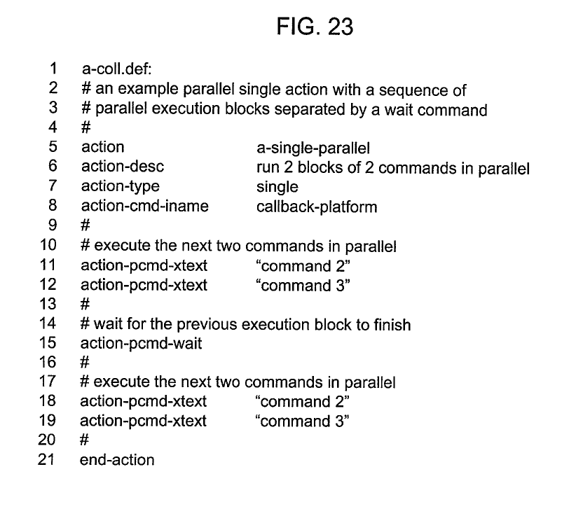

Boundaries between sequences of parallel execution blocks are indicated by a special token name of “action-pcmd-wait” FIG. 23 Line 15. Line 15 specifies that all commands in the previous parallel execution block Lines 11-12 should finish before any commands in the next parallel execution block Lines 18-19 are started.

Actions: Parallel Group Actions

Parallel group actions execute whole actions in parallel.

FIG. 24 shows an example group action that is comprised of two single actions that are to be executed in parallel. Parallel execution of actions is indicated by a “action-pcmd-aname” token such as shown in FIG. 24 Lines 8-9. Line 8 names a single action to select a collection from a list of collections. Line 9 names a single action to build and install the selected collection.

In operation, Module Execute Group Action 152 uses a parallel execution technique (such as multiple threads) to execute whole actions in parallel. For example, both single actions named in FIG. 24 Lines 8-9 are executed in parallel. Execution of each single action is still performed by Module Execute Single Action 170, but each such execution is done in parallel with others in its parallel execution block.

Actions can be organized into sequences of interleaved sequential and parallel execution blocks.

FIG. 25 Lines 10-18 show how 4 actions can be organized into 3 execution blocks, as follows: action 1 executed in sequence, actions 2 and 3 executed in parallel, action 4 executed in sequence. Module Execute Group Action 152 waits for all parallel action executions in a parallel execution block to finish before proceeding. Thus it would wait for actions 2 and 3 to finish before starting execution of action 4. Techniques for waiting for parallel processes to finish are well known to the art.

Module Execute Group Action 152 can detect the boundaries of interleaved sequential and parallel execution blocks by examination of the token names in Column 1 of an action definition file FIG. 25. A change from “action-cmd-aname” Line 11 to “action-pcmd-aname”Line 14 (or vice versa Line 15 to Line 18) indicates the boundary of an execution block.

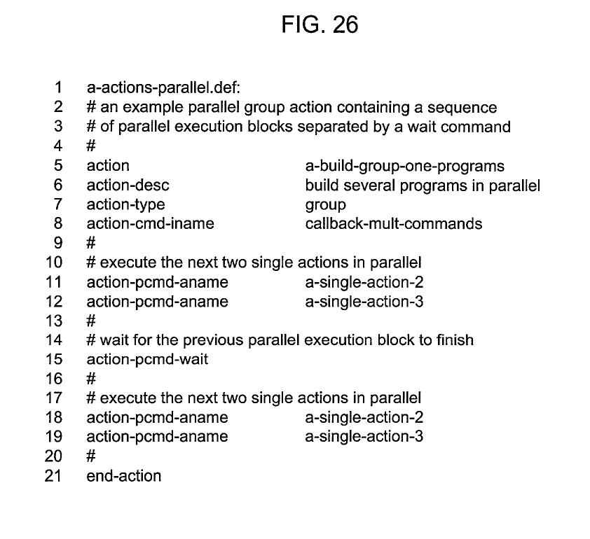

Boundaries between sequences of parallel execution blocks are indicated by a special token name of “action-pcmd-wait” FIG. 26 Line 15. Line 15 specifies that all actions in the previous parallel execution block Lines 11-12 should finish before any actions in the next parallel execution block Lines 18-19 are started.

Parallel group actions can execute other group actions in parallel using the methods described above. Parallel execution in group actions is not limited to executing only single actions in parallel.

Further Advantages

A Collection Extensible Action GUI can be extended by creating new action data files that specify new actions. This makes it possible to customize and extend GUI actions to suit the precise computational needs of human operators, a capability that was not previously possible.

### Conclusion

The present Collection Extensible Action GUI invention provides practical solutions to nine important problems faced by builders of extensible graphical user interfaces.

The nine problems solved are these: (1) the overall Extensible Action GUI Problem, (2) the Parameterized Action Problem, (3) the Sequenced Action Problem, (4) the Dynamic List Generation Problem, (5) the Single Action Parallel Execution Problem, (6) the Group Action Parallel Execution Problem, (7) the Customized Action Problem, (8) the Sharable Action Problem, and (9) the Scalable Action Problem.

The present Collection Extensible Action GUI invention provides human users with a practical means for extending GUI interfaces to suit the precise computational needs of human operators, in ways that were not previously possible.

### Ramifications

Although the foregoing descriptions are specific, they should be considered as example embodiments of the invention, and not as limitations. Those skilled in the art will understand that many other possible ramifications can be imagined without departing from the spirit and scope of the present invention.

General Software Ramifications

The foregoing disclosure has recited particular combinations of program architecture, data structures, and algorithms to describe preferred embodiments. However, those of ordinary skill in the software art can appreciate that many other equivalent software embodiments are possible within the teachings of the present invention.

As one example, data structures have been described here as coherent single data structures for convenience of presentation. But information could also be could be spread across a different set of coherent data structures, or could be split into a plurality of smaller data structures for implementation convenience, without loss of purpose or functionality.

As a second example, particular software architectures have been presented here to more strongly associate primary algorithmic actions with primary modules in the software architectures. However, because software is so flexible, many different associations of algorithmic functionality and module architecture are also possible, without loss of purpose or technical capability. At the under-modularized extreme, all algorithmic functionality could be contained in one software module. At the over-modularized extreme, each tiny algorithmic action could be contained in a separate software module.

As a third example, particular simplified algorithms have been presented here to generally describe the primary algorithmic actions and operations of the invention. However, those skilled in the software art know that other equivalent algorithms are also easily possible. For example, if independent data items are being processed, the algorithmic order of nested loops can be changed, the order of functionally treating items can be changed, and so on.

Those skilled in the software art can appreciate that architectural, algorithmic, and resource tradeoffs are ubiquitous in the software art, and are typically resolved by particular implementation choices made for particular reasons that are important for each implementation at the time of its construction. The architectures, algorithms, and data structures presented above comprise one such conceptual implementation, which was chosen to emphasize conceptual clarity.

From the above, it can be seen that there are many possible equivalent implementations of almost any software architecture or algorithm, regardless of most implementation differences that might exist. Thus when considering algorithmic and functional equivalence, the essential inputs, outputs, associations, and applications of information that truly characterize an algorithm should be considered. These characteristics are much more fundamental to a software invention than are flexible architectures, simplified algorithms, or particular organizations of data structures.

Practical Applications

A Collection Extensible Action GUI can be used in various practical applications.

One possible application is to improve the productivity of human knowledge workers, by providing them with a practical means for extending the functionality offered by GUI interfaces to precisely match user work requirements.

Another application is to improve the usability of modern GUI interfaces by reducing the number of provided GUI actions to an optimal set of GUI actions that is well-adapted to the current work situation.

Another application is to centralize the administration of action knowledge within a community of users; one central store of actions can be accessed by many users through use of Collection Extensible Action GUIs. This strategy shifts the burden of understanding and maintaining action knowledge from the many to the few. A Collection Knowledge System (see the related patent application section of this document) is particularly well suited for this purpose.

Other Sources of Action Requests

The foregoing disclosure described action requests as being primarily initiated by humans using GUI controls such as menus or toolbar buttons. However, other request sources are also possible.

For example, action requests can be generated by other programs and sent to a Collection Extensible Action GUI for interpretation. A program that completes a computation could send an action request to a Collection Extensible Action GUI. In response, a Collection Extensible Action GUI could execute a corresponding GUI action to notify users, or to initiate another phase of execution.

Other Action Data Stores

The foregoing discussion identified an Action Data Storage Means 121 as one preferred means for storing adaptation knowledge used by a Collection Extensible Action GUI. However, other storage means are also possible.

For example, a relational database might be used to advantage, especially where large numbers of actions are involved. As another example, a network action data server could provide action data to client Collection Extensible Action GUIs by using a client-server protocol means. As a third example, action data might be stored and provided to client GUI programs by using an XML markup language representation, or by using a web server protocol such as HTTP.

Another important implementation of an Action Data Storage Means 121 is a Collection Knowledge System, which contains knowledge search rules, context-sensitive behaviors, and client/server mechanisms that are useful for customization, sharing, and scalability. For more detailed information on Collection Knowledge Systems, see the related patent applications listed at the beginning of this document.

As can be seen by one of ordinary skill in the art, many other ramifications are also possible within the teachings of this invention.

### Scope

The full scope of the present invention should be determined by the accompanying claims and their legal equivalents, rather than from the examples given in the specification.

I claim:

1. A Collection Extensible Action GUI process for executing a GUI action, comprising the following steps:
(a) receiving an action execution request, and
(b) performing an action execution response to said action execution request,
thereby providing a solution to the Collection Extensible Action GUI Problem, and
thereby providing human users with a practical means for extending the functionality of graphical user interfaces in a way that was not previously possible.

2. The process of claim 1, wherein
(a) said step of receiving an action execution request receives an action execution request from a source selected from the group consisting of human operators and external programs and a GUI program that is executing said step of receiving an action execution request,
thereby helping to solve the Collection Extensible Action GUI Problem, and
thereby providing GUI interfaces with a practical means for responding to action execution requests that originate from both inside and outside the GUI program.

3. The process of claim 1, wherein
(a) said step of performing an action execution response obtains an action identifier from said action execution request,
thereby helping to solve the Collection Extensible Action GUI Problem, and
thereby providing a practical means for clearly identifying a particular action to be executed as part of said action execution response

4. The process of claim 1, wherein
(a) said step of performing an action execution response uses an action identifier, and action data read from an action data storage means, to perform a name matching operation to identify an action definition to be executed,
thereby helping to solve the Collection Extensible Action GUI Problem, and the Customized Action Problem, and the Sharable Action Problem, and the Scalable Action Storage Problem,
and thereby providing a practical means for identifying a particular action definition to be executed as part of said action execution response.

5. The process of claim 1, wherein
(a) said step of performing an action execution response uses action definition data read from an action data storage means to perform said action execution response,
thereby helping to solve the Collection Extensible Action GUI Problem, and the Customized Action Problem, and the Sharable Action Problem, and the Scalable Action Storage Problem,
and thereby providing a practical means for obtaining an action definition to be executed as part of said action execution response.

6. The process of claim 1, wherein
(a) said step of performing an action execution response uses action definition data read from a context-sensitive action data storage means to perform said action execution response,
thereby helping to solve the Collection Extensible Action GUI Problem, and the Customized Action Problem, and the Sharable Action Problem, and the Scalable Action Storage Problem,
and thereby providing a practical means for obtaining in a context-sensitive way an action definition to be executed as part of said action execution response.

7. The process of claim 1, wherein
(a) said step of performing an action execution response obtains an action type indicator from an action definition,
thereby helping to solve the Sequenced Action Problem,
and thereby providing a practical means for identifying single actions and group actions as part of said action execution response.

8. The process of claim 1, wherein
(a) said step of performing an action execution response executes an action whose type is selected from the group consisting of single actions and group actions,
thereby helping to solve the Sequenced Action Problem,
and thereby providing a practical means for executing single actions and group actions as part of said action execution response.

9. The process of claim 1, wherein
(a) said step of performing an action execution response uses action data read from an action data storage means to perform said action execution response,
thereby helping to solve the Collection Extensible Action GUI Problem, and the Customized Action Problem, and the Sharable Action Problem, and the Scalable Action Storage Problem,
and thereby providing a practical means for obtaining action data to use during the performance of said action execution response.

10. The process of claim 1, wherein
(a) said step of performing an action execution response uses action data read from a context-sensitive action data storage means to perform said action execution response,
thereby helping to solve the Collection Extensible Action GUI Problem, and the Customized Action Problem, and the Sharable Action Problem, and the Scalable Action Storage Problem,
and thereby providing a practical means for obtaining in a context-sensitive way action data to use during the performance of said action execution response.

11. The process of claim 1, wherein
(a) said step of performing an action execution response executes a single action,
thereby helping to solve the Collection Extensible Action GUI Problem,
and thereby providing a practical means for executing single actions as part of said action execution response.

12. The process of claim 1, wherein
(a) said step of performing an action execution response executes a group action,
thereby helping to solve the Collection Extensible Action GUI Problem, and the Sequenced Action Problem,
and thereby providing a practical means for executing group actions and single actions as part of said action execution response.

13. The process of claim 1, wherein
(a) said step of performing an action execution response executes a single action using a parallel execution technique,
thereby solving the Single Action Parallel Execution Problem,
and thereby providing a practical means for improving the execution performance of single actions executed as part of said action execution response.

14. The process of claim 1, wherein
(a) said step of performing an action execution response executes a group action using a parallel execution technique,
thereby solving the Group Action Parallel Execution Problem,
and thereby providing a practical means for improving the execution performance of group actions executed as part of said action execution response.

15. The process of claim 1, wherein
(a) said step of performing an action execution response uses zero or more focus variable substitutions to construct an executable action command,
thereby solving the Parameterized Action Problem,
and thereby providing a practical means for inserting current parameter values into an action command template as part of said action execution response.

16. The process of claim 1, wherein
(a) said step of performing an action execution response uses a dynamic list to construct an action dialog,
thereby solving the Dynamic List Generation Problem,
and thereby providing a practical means for inserting lists of current data values into an action dialog as part of said action execution response.

17. The process of claim 1, wherein
(a) said step of performing an action execution response communicates action execution results to one or more destinations selected from the group consisting of computer memories and computer display screens and computer files and computer networks,
thereby helping to solve the Collection Extensible Action GUI Problem,
and thereby providing a practical means for displaying and storing action execution results as part of said action execution response.

18. A programmable Collection Extensible Action GUI device for executing a GUI action, whose actions are directed by software executing a process comprising the following steps:
(a) receiving an action execution request, and
(b) performing an action execution response to said action execution request,
thereby providing a solution to the Collection Extensible Action GUI Problem, and
thereby providing human users with a practical means for extending the functionality of graphical user interfaces in a way that was not previously possible.

19. The programmable device of claim 18, wherein
(a) said step of receiving an action execution request receives an action execution request from a source selected from the group consisting of human operators and external programs and a GUI program that is executing said step of receiving an action execution request,
thereby helping to solve the Collection Extensible Action GUI Problem, and
thereby providing GUI interfaces with a practical means for responding to action execution requests that originate from both inside and outside the GUI program.

20. The programmable device of claim 18, wherein
(a) said step of performing an action execution response obtains an action identifier from said action execution request,
thereby helping to solve the Collection Extensible Action GUI Problem, and
thereby providing a practical means for clearly identifying a particular action to be executed as part of said action execution response.

21. The programmable device of claim 18, wherein
(a) said step of performing an action execution response uses an action identifier, and action data read from an action data storage means, to perform a name matching operation to identify an action definition to be executed,
thereby helping to solve the Collection Extensible Action GUI Problem, and the Customized Action Problem, and the Sharable Action Problem, and the Scalable Action Storage Problem,
and thereby providing a practical means for identifying a particular action definition to be executed as part of said action execution response.

22. The programmable device of claim 18, wherein
(a) said step of performing an action execution response uses action definition data read from an action data storage means to perform said action execution response,
thereby helping to solve the Collection Extensible Action GUI Problem, and the Customized Action Problem, and the Sharable Action Problem, and the Scalable Action Storage Problem,
and thereby providing a practical means for obtaining an action definition to be executed as part of said action execution response.

23. The programmable device of claim 18, wherein
(a) said step of performing an action execution response uses action definition data read from a context-sensitive action data storage means to perform said action execution response,
thereby helping to solve the Collection Extensible Action GUI Problem, and the Customized Action Problem, and the Sharable Action Problem, and the Scalable Action Storage Problem,
and thereby providing a practical means for obtaining in a context-sensitive way an action definition to be executed as part of said action execution response.

24. The programmable device of claim 18, wherein
(a) said step of performing an action execution response obtains an action type indicator from an action definition,
thereby helping to solve the Sequenced Action Problem,
and thereby providing a practical means for identifying single actions and group actions as part of said action execution response.

25. The programmable device of claim 18, wherein
(a) said step of performing an action execution response executes an action whose type is selected from the group consisting of single actions and group actions,
thereby helping to solve the Sequenced Action Problem,
and thereby providing a practical means for executing single actions and group actions as part of said action execution response.

26. The programmable device of claim 18, wherein
(a) said step of performing an action execution response uses action data read from an action data storage means to perform said action execution response,
thereby helping to solve the Collection Extensible Action GUI Problem, and the Customized Action Problem, and the Sharable Action Problem, and the Scalable Action Storage Problem,
and thereby providing a practical means for obtaining action data to use during the performance of said action execution response.

27. The programmable device of claim 18, wherein
(a) said step of performing an action execution response uses action data read from a context-sensitive action data storage means to perform said action execution response,
thereby helping to solve the Collection Extensible Action GUI Problem, and the Customized Action Problem, and the Sharable Action Problem, and the Scalable Action Storage Problem,
and thereby providing a practical means for obtaining in a context-sensitive way action data to use during the performance of said action execution response.

28. The programmable device of claim 18, wherein
(a) said step of performing an action execution response executes a single action,
thereby helping to solve the Collection Extensible Action GUI Problem,
and thereby providing a practical means for executing single actions as part of said action execution response.

29. The programmable device of claim 18, wherein
(a) said step of performing an action execution response executes a group action,
thereby helping to solve the Collection Extensible Action GUI Problem, and the Sequenced Action Problem,
and thereby providing a practical means for executing group actions and single actions as part of said action execution response.

30. The programmable device of claim 18, wherein
(a) said step of performing an action execution response executes a single action using a parallel execution technique,
thereby solving the Single Action Parallel Execution Problem,
and thereby providing a practical means for improving the execution performance of single actions executed as part of said action execution response.

31. The programmable device of claim 18, wherein
(a) said step of performing an action execution response executes a group action using a parallel execution technique,
thereby solving the Group Action Parallel Execution Problem,
and thereby providing a practical means for improving the execution performance of group actions executed as part of said action execution response.

32. The programmable device of claim 18, wherein
(a) said step of performing an action execution response uses zero or more focus variable substitutions to construct an executable action command,
thereby solving the Parameterized Action Problem,
and thereby providing a practical means for inserting current parameter values into an action command template as part of said action execution response.

33. The programmable device of claim 18, wherein
(a) said step of performing an action execution response uses a dynamic list to construct an action dialog,
thereby solving the Dynamic List Generation Problem,
and thereby providing a practical means for inserting lists of current data values into an action dialog as part of said action execution response.

34. The programmable device of claim 18, wherein
(a) said step of performing an action execution response communicates action execution results to one or more destinations selected from the group consisting of computer memories and computer display screens and computer files and computer networks,
thereby helping to solve the Collection Extensible Action GUI Problem,
and thereby providing a practical means for displaying and storing action execution results as part of said action execution response.

35. A computer readable memory, encoded with data representing a Collection Extensible Action GUI program that can be used to direct a computer when used by the computer, comprising:
(a) means for receiving an action execution request, and
(b) means for performing an action execution response to said action execution request,
thereby providing a solution to the Collection Extensible Action GUI Problem, and
thereby providing human users with a practical means for extending the functionality of graphical user interfaces in a way that was not previously possible.

36. The computer readable memory of claim 35, wherein
(a) said means for receiving an action execution request receives an action request from a source selected from the group consisting of human operators and external programs and a GUI program that is executing said step of receiving an action execution request,
thereby helping to solve the Collection Extensible Action GUI Problem, and
thereby providing GUI interfaces with a practical means for responding to action execution requests that originate from both inside and outside the GUI program.

37. The computer readable memory of claim 35, wherein
(a) said means for performing an action execution response obtains an action identifier from said action execution request,
thereby helping to solve the Collection Extensible Action GUI Problem, and
thereby providing a practical means for clearly identifying a particular action to be executed as part of said action execution response.

38. The computer readable memory of claim 35, wherein
(a) said means for performing an action execution response uses an action identifier, and action data read from an action data storage means, to perform a name matching operation to identify an action definition to be executed,
thereby helping to solve the Collection Extensible Action GUI Problem, and the Customized Action Problem, and the Sharable Action Problem, and the Scalable Action Storage Problem,
and thereby providing a practical means for identifying a particular action definition to be executed as part of said action execution response.

39. The computer readable memory of claim 35, wherein
(a) said means for performing an action execution response uses action definition data read from an action data storage means to perform said action execution response,
thereby helping to solve the Collection Extensible Action GUI Problem, and the Customized Action Problem, and the Sharable Action Problem, and the Scalable Action Storage Problem,
and thereby providing a practical means for obtaining an action definition to be executed as part of said action execution response.

40. The computer readable memory of claim 35, wherein
(a) said means for performing an action execution response uses action definition data read from a context-sensitive action data storage means to perform said action execution response,
thereby helping to solve the Collection Extensible Action GUI Problem, and the Customized Action Problem, and the Sharable Action Problem, and the Scalable Action Storage Problem,
and thereby providing a practical means for obtaining in a context-sensitive way an action definition to be executed as part of said action execution response.

41. The computer readable memory of claim 35, wherein
(a) said means for performing an action execution response obtains an action type indicator from an action definition,
thereby helping to solve the Sequenced Action Problem,
and thereby providing a practical means for identifying single actions and group actions as part of said action execution response.

42. The computer readable memory of claim 35, wherein
(a) said means for performing an action execution response executes an action whose type is selected from the group consisting of single actions and group actions,
thereby helping to solve the Sequenced Action Problem,
and thereby providing a practical means for executing single actions and group actions as part of said action execution response.

43. The computer readable memory of claim 35, wherein
(a) said means for performing an action execution response uses action data read from an action data storage means to perform said action execution response,
thereby helping to solve the Collection Extensible Action GUI Problem, and the Customized Action Problem, and the Sharable Action Problem, and the Scalable Action Storage Problem,
and thereby providing a practical means for obtaining action data to use during the performance of said action execution response.

44. The computer readable memory of claim 35, wherein
(a) said means for performing an action execution response uses action data read from a context-sensitive action data storage means to perform said action execution response,
thereby helping to solve the Collection Extensible Action GUI Problem, and the Customized Action Problem, and the Sharable Action Problem, and the Scalable Action Storage Problem,
and thereby providing a practical means for obtaining in a context-sensitive way action data to use during the performance of said action execution response.

45. The computer readable memory of claim 35, wherein
(a) said means for performing an action execution response executes a single action,
thereby helping to solve the Collection Extensible Action GUI Problem,
and thereby providing a practical means for executing single actions as part of said action execution response.

46. The computer readable memory of claim 35, wherein
(a) said means for performing an action execution response executes a group action,
thereby helping to solve the Collection Extensible Action GUI Problem, and the Sequenced Action Problem,
and thereby providing a practical means for executing group actions and single actions as part of said action execution response.

47. The computer readable memory of claim 35, wherein
(a) said means for performing an action execution response executes a single action using a parallel execution technique,
thereby solving the Single Action Parallel Execution Problem,
and thereby providing a practical means for improving the execution performance of single actions executed as part of said action execution response.

48. The computer readable memory of claim 35, wherein
(a) said means for performing an action execution response executes a group action using a parallel execution technique,
thereby solving the Group Action Parallel Execution Problem,
and thereby providing a practical means for improving the execution performance of group actions executed as part of said action execution response.

49. The computer readable memory of claim 35, wherein
(a) said means for performing an action execution response uses zero or more focus variable substitutions to construct an executable action command,
thereby solving the Parameterized Action Problem,
and thereby providing a practical means for inserting current parameter values into an action command template as part of said action execution response.

50. The computer readable memory of claim 35, wherein
(a) said means for performing an action execution response uses a dynamic list to construct an action dialog,
thereby solving the Dynamic List Generation Problem,
and thereby providing a practical means for inserting lists of current data values into an action dialog as part of said action execution response.

51. The computer readable memory of claim 35, wherein
(a) said means for performing an action execution response communicates action execution results to one or more destinations selected from the group consisting of computer memories and computer display screens and computer files and computer networks,
thereby helping to solve the Collection Extensible Action GUI Problem,
and thereby providing a practical means for displaying and storing action execution results as part of said action execution response.
